(19) United States
(12) Patent Application Publication
(10) Pub. No.: US 2026/0205921 A1
(43) Pub. Date: Jul. 16, 2026

(54) METHOD FOR WIRELESS COMMUNICATION AND DEVICE

(71) Applicant: GUANGDONG OPPO MOBILE TELECOMMUNICATIONS CORP., LTD., Dongguan (CN)

(72) Inventor: Nande ZHAO, Dongguan (CN)

(21) Appl. No.: 19/563,005

(22) Filed: Mar. 11, 2026

Related U.S. Application Data
(63) Continuation of application No. PCT/CN2023/124605, filed on Oct. 13, 2023.

(51) Int. Cl. H04W 48/12

(52) U.S. Cl. CPC H04W 48/12

(57) ABSTRACT

Provided is a method for wireless communication and a device relating to the technical field of communications. The method is performed by a terminal device and includes: receiving, within a first periodicity, a synchronization signal block (SSB) from a network device, wherein the first periodicity is greater than or equal to 20 ms.

### CROSS REFERENCE TO RELATED APPLICATION

This application is a continuation of International Application No. PCT/CN2023/124605, filed Oct. 13, 2023, the entire disclosure of which is incorporated herein by reference.

### TECHNICAL FIELD

Embodiments of the present disclosure relate to the technical field of communications, and in particular, relate to a method for wireless communication and a device.

### RELATED ART

In a non-terrestrial network (NTN) system, a large number of beams are needed to satisfy coverage requirements of a network device due to a vast coverage of the network device. Considering that the network device has limited transmit power and processing capabilities, it is difficult to activate too many beams simultaneously. Therefore, beam sweeping may be adopted to provide services to a cell within the coverage of the network device. For example, a synchronization signal/physical broadcast channel block (SSB) may be transmitted to the cell by beam sweeping.

In related arts, a terminal device assumes a 20 ms SSB periodicity during an initial cell selection. However, the beam corresponding to the terminal device may fail to be activated within 20 ms to transmit the SSB, resulting in a cell search failure on the terminal device.

### SUMMARY

Embodiments of the present disclosure provide a method for wireless communication and a device.

According to some embodiments of the present disclosure, a method for wireless communication is provided. The method is performed by a terminal device, and includes:
receiving, within a first periodicity, an SSB from a network device, wherein the first periodicity is greater than or equal to 20 ms.

According to some embodiments of the present disclosure, a terminal device is provided. The terminal device includes: a processor and a memory storing one or more computer programs, wherein the processor executes the one or more computer programs to perform:
receiving, within a first periodicity, an SSB from a network device, wherein the first periodicity is greater than or equal to 20 ms.

According to some embodiments of the present disclosure, a network device is provided. The network device includes: a processor and a memory storing one or more computer programs; wherein the processor executes the one or more computer programs to perform:
transmitting, based on a first periodicity, an SSB to a cell of a terminal device, wherein the first periodicity is greater than or equal to 20 ms.

### BRIEF DESCRIPTION OF DRAWINGS

FIG. 1 is a schematic diagram of a network architecture according to some embodiments of the present disclosure;

FIG. 2 is a schematic diagram of a time-division beam activation covering surface areas according to some embodiments of the present disclosure;

FIG. 3 is a schematic flowchart of a method for wireless communication according to some embodiments of the present disclosure;

FIG. 4 is a schematic diagram of a first time-window according to some embodiments of the present disclosure;

FIG. 5 is a schematic diagram where frame boundaries of different cell groups are offset according to some embodiments of the present disclosure;

FIG. 6 is a schematic diagram where frame boundaries of different cell groups are aligned according to some embodiments of the present disclosure;

FIG. 7 is a schematic diagram of a candidate SSB pattern where a subcarrier spacing (SCS)=15 kHz according to some embodiments of the present disclosure;

FIG. 8 is a schematic diagram of a candidate SSB pattern where an SCS=30 kHz according to some embodiments of the present disclosure;

FIG. 9 is another schematic diagram of a candidate SSB pattern where an SCS=30 kHz according to some embodiments of the present disclosure;

FIG. 10 is a schematic diagram of a cell SSB set where an SCS=15 kHz according to some embodiments of the present disclosure;

FIG. 11 is a schematic block diagram of a wireless communication apparatus according to some embodiments of the present disclosure;

FIG. 12 is another schematic block diagram of a wireless communication apparatus according to some embodiments of the present disclosure;

FIG. 13 is a schematic structural diagram of a terminal device according to some embodiments of the present disclosure; and

FIG. 14 is a schematic structural diagram of a network device according to some embodiments of the present disclosure.

### DETAILED DESCRIPTION

For clearer descriptions of the technical solutions according to the embodiments of the present disclosure, the embodiments of the present disclosure are described hereinafter in combination with the accompanying drawings.

The network architecture and service scenarios described in the embodiments of the present disclosure are intended to illustrate more clearly rather than to limit the technical solutions according to the embodiments of the present disclosure. Those skilled in the art understand that with evolution of the network architecture and emergence of new service scenarios, the technical solutions according to the embodiments of the present disclosure are also applicable to addressing similar technical problems.

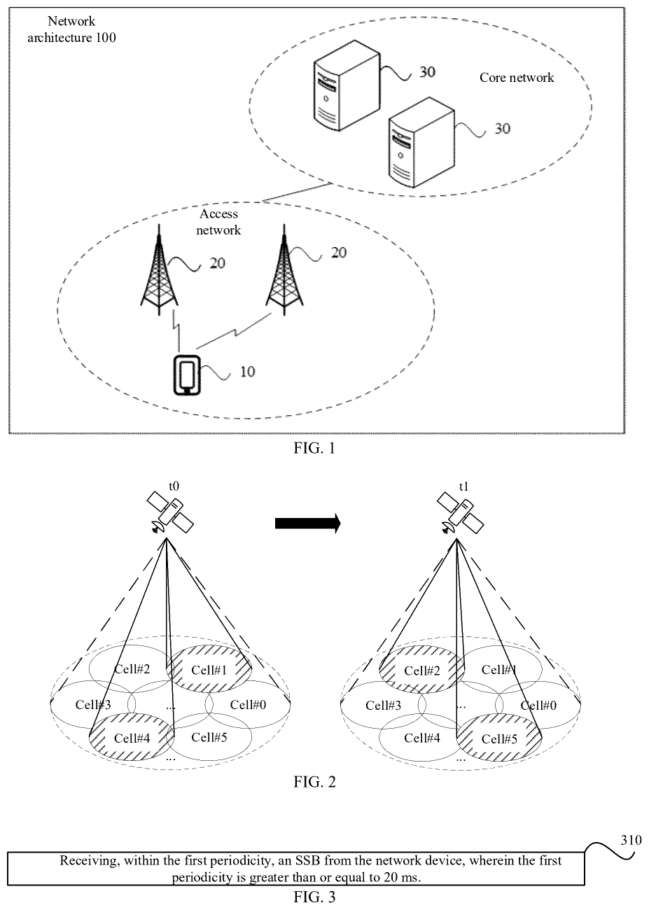

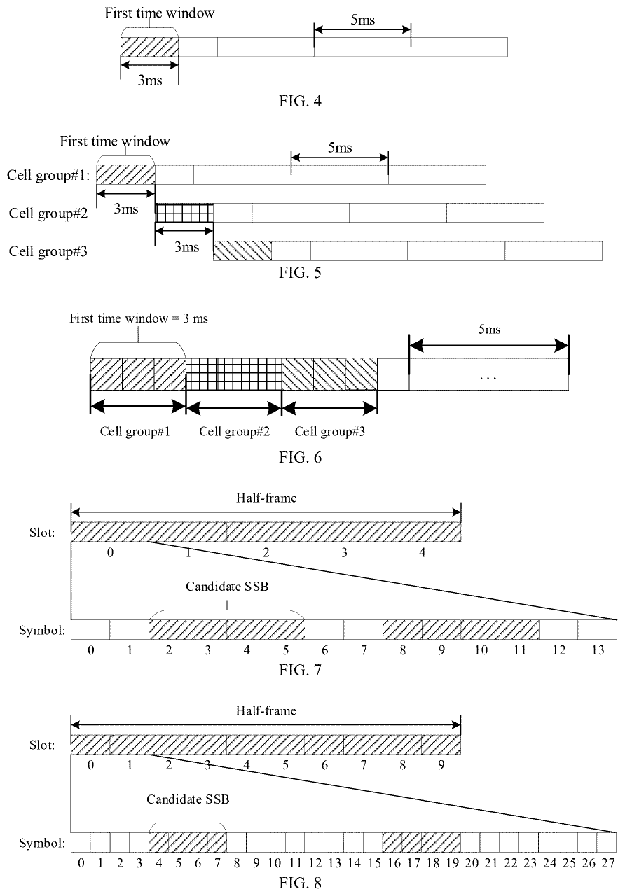

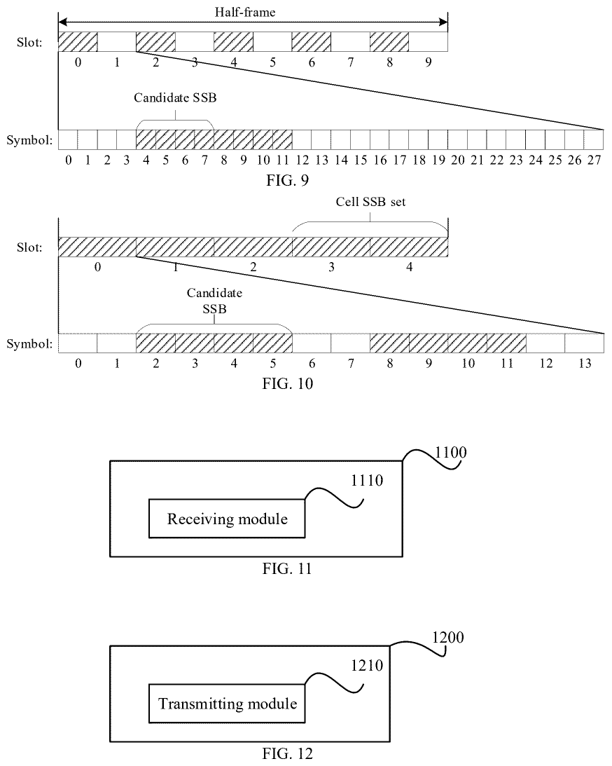

FIG. 1 is a schematic diagram of a network architecture 100 according to some embodiments of the present disclosure. The network architecture 100 may include a terminal device 10, an access network device 20, and a core network unit 30.

The terminal device 10 may refer to a user equipment (UE), an access terminal, a subscriber unit, a subscriber station, a mobile station, a mobile stage, a remote station, a remote terminal, a mobile device, a wireless communication device, a user agent, or user apparatus. In some embodiments, the terminal device 10 may also be a cellular phone, a cordless phone, a Session Initiation Protocol (SIP) phone, a wireless local loop (WLL) station, a personal digital assistant (PDA) device, a hand-held device with wireless communication capabilities, a computing device or other processing devices connected to a wireless modem, an in-vehicle device, a wearable device, a terminal device in a 5^{th} generation system (5GS), or a terminal device in an evolved public land mobile network (PLMN), or the like, which are not limited in the embodiments of the present disclosure. For ease of description, the devices above are collectively referred to as terminal devices. A plurality of terminal devices 10 are generally provided, and one or more terminal devices 10 may be distributed within each cell managed by the access network device 20. The terminal devices may also be referred to simply as terminals or UEs, which is understandable by those skilled in the art.

The access network device 20 is a device deployed within an access network to provide wireless communication functionality for the terminal devices 10. The access network device 20 may include various forms such as macro base stations, micro base stations, relay stations, access points, and the like. In systems employing different wireless access technologies, the name of the device performing access network device functions may vary. For example, in a 5G NR system, the access network device 20 may be referred to as a gNodeB or a gNB. As communication technologies evolve, the name “access network device” may change. Illustratively, in the long-term evolution (LTE) system, the access network device 20 may be an evolved universal terrestrial radio access network (EUTRAN) or one or more eNodeBs within the EUTRAN. In the 5G NR system, the access network device 20 may be a radio access network (RAN) or one or more gNBs within the RAN. In the embodiments of the present disclosure, unless otherwise specified, the term “network device” refers to the access network device 20, such as a base station.

The core network unit 30 is deployed within the core network. The functions of core network unit 30 primarily involve providing user connectivity, managing users, carrying out service completion, and serving as the interface to external networks as a transport network. For example, core network units in a 5G NR system may include an access and mobility management function (AMF) entity, a user plane function (UPF) entity, a session management function (SMF) entity, and other network units.

In some embodiments, the access network device 20 and the core network unit 30 communicate with each other via an air interface technology, such as an NG interface in the 5G NR system. The access network device 20 and the terminal device 10 communicate with each other via an air interface technology, such as a Uu interface.

The “5G NR system” in the embodiments of the present disclosure may also be referred to as the 5G system or NR system, but those skilled in the art will understand the meaning. The technical solutions described in the embodiments of the present disclosure may be applicable to LTE systems, 5G NR systems, subsequent evolution systems of 5G NR systems (e.g., Beyond 5G (B5G) systems, 6^{th} Generation (6G) systems), as well as other communication systems such as narrowband Internet of things (NB-IoT) systems, which are not limited in the embodiments of the present disclosure.

In the embodiments of the present disclosure, the network device provides services for cells, and the terminal device communicates with the network device over the transmission resources (e.g., frequency domain resources, or spectrum resources) used in the cells. The cell is a cell corresponding to the network device (e.g., the base station), and the cell may belong to the macro base station or a base station corresponding to a small cell. The small cell may include a metro cell, a micro cell, a pico cell, or a femto cell, or the like. The small cells have the small coverage and low transmission power, and are suitable for providing high-rate data transmission services.

Before introducing the technical solutions of the present disclosure, an introduction to some relevant technical knowledge involved in the present disclosure is provided. The following related technologies may be arbitrarily combined with the technical solutions of the embodiments of the present disclosure as optional alternatives, and all belong within the scope of protection of the embodiments of the present disclosure. The embodiments of the present disclosure include at least some of the following content.

### 1. a Cell Search Process in the NR System

The cell search is a process by which the terminal device acquires cell time-frequency synchronization and detects a physical layer identifier (ID). To perform the cell search, the terminal device receives a primary synchronization signal (PSS) and a secondary synchronization signal (SSS), and it is assumed that the PBCH, the PSS, and the SSS are on consecutive symbols to form an SSB.

For a half-frame carrying the SSB, a first symbol index of a candidate SSB is determined based on a subcarrier spacing, wherein an index 0 corresponds to the first symbol index of a first slot within the half-frame. Specifically:
Pattern A—15 kHz SCS: The first symbol index of the candidate SSB is {2, 8}+14 n.

For a non-shared spectrum channel access: in a case where a carrier frequency is less than or equal to 3 GHz, n=0, 1; or in a case where the carrier frequency within frequency range 1 (FR1) is greater than 3 GHz, n=0, 1, 2, 3.

For a shared spectrum channel access: n=0, 1, 2, 3, 4.
Pattern B—30 kHz SCS: The first symbol index of the candidate SSB is {4, 8, 16, 20}+28 n.
Pattern C—30 kHz SCS: The first symbol index of the candidate SSB is {2, 8}+14 n.

For a non-shared spectrum channel access: For a paired spectrum, in a case where a carrier frequency is less than or equal to 3 GHz, n=0, 1; or in a case where FR1 is greater than 3 GHz, n=0, 1, 2, 3; for a non-paired spectrum, in a case where a carrier frequency is less than or equal to 1.88 GHz, n=0, 1; or in a case where FR1 is greater than 1.88 GHz, n=0, 1, 2, 3.

For a shared spectrum channel access: n=0, 1, 2, 3, 4, 5, 6, 7, 8, 9.
Pattern D—120 kHz: The first symbol index of the candidate SSB is {4, 8, 16, 20}+28 n. For a carrier frequency within FR2, n=0, 1, 2, 3, 5, 6, 7, 8, 10, 11, 12, 13, 15, 16, 17, 18.
Pattern E—240 kHz: The first symbol index of the candidate SSB is {8, 12, 16, 20, 32, 36, 40, 44}+28 n. For a carrier frequency within FR2-1, n=0, 1, 2, 3, 5, 6, 7, 8.
Pattern F—480 kHz: The first symbol index of the candidate SSBs is {2, 9}+14 n. For a carrier frequency within FR2-2, n=0, 1, 2 . . . 29, 30, 31.
Pattern G—960 kHz: The first symbol index of the candidate SSB is {2, 9}+14 n. For a carrier frequency within FR2-2, n=0, 1, 2 . . . 29, 30, 31.

The candidate SSBs within a half-frame are indexed in an ascending order from 0 to L̅ₘₐₓ−1, wherein L̅ₘₐₓ is determined based on the SSB patterns A to G. L̅ₘₐₓ is a largest value of a cell SSB index, i. e., a largest number of SSBs transmitted within the half-frame is Lₘₐₓ.

For FR1 and the non-shared spectrum channel access within FR2, and the shared-spectrum channel access within FR2-2, Lₘₐₓ=L̅ₘₐₓ.

For the shared spectrum channel access within FR1, for the SSB with L̅ₘₐₓ=10 and 15 kHz SCS, and the SSB with L̅ₘₐₓ=20 and 30 kHz SCS, Lₘₐₓ=8.

For L̅ₘₐₓ=4, the terminal device determines, based on a one-to-one mapping, two least significant bits (LSBs) of an index of the candidate SSB within the half-frame from an index of a demodulation reference signal (DMRS) sequence transmitted on the PBCH.

For L̅ₘₐₓ>4, the terminal device determines, based on a one-to-one mapping, three LSBs of index of the candidate SSB within the half-frame from an index of a DRMS sequence transmitted on the PBCH.

For L̅ₘₐₓ=10, the terminal device determines one most significant bit (MSB) of the index of the candidate SSB based on information bit ā_{Ā+7} on the PBCH.

For L̅ₘₐₓ=20, the terminal device determines two MSBs of the index of the candidate SSB based on information bits ā_{Ā+6} and ā_{Ā+7} on the PBCH.

For L̅ₘₐₓ=64, the terminal device determines three MSBs based on information bits ā_{Ā+5}, ā_{Ā+6}, and ā_{Ā+7} on the PBCH.

A parameter ssb-periodicityServingCell provides the terminal device one half-frame periodicity for receiving the SSB of cell services in each serving cell. In a case where the terminal device is not configured with the half-frame periodicity to receive the SSB, a half-frame periodicity is assumed. The terminal device assumes the same SSB periodicity for the serving cell. During an initial cell selection, the terminal device assumes two frames for the half-frame periodicity for receiving the SSB.

In an NTN system, a low Earth orbit (LEO) satellite is expected to cover a ground area with an elevation angle of 30 to 90 degrees, with a coverage area diameter of more than 1500 km. A diameter of a satellite beam provided by an LEO-600 is approximately 50 km, in this case, more than 1000 satellites are needed to meet the requirement of the elevation angle being 30 to 90 degrees. Considering that the satellite transmission efficiency and processing power are limited, it is impractical to simultaneously activate more than 1000 satellite beams. Therefore, it is an urgent problem to be solved to achieve a system-wide coverage expansion by adopting an effective satellite beam sweeping scheme to meet the satellite coverage requirements.

Considering the limited number of beams that may be activated simultaneously, it is only possible to provide services to a portion of the ground area, and thus a time-division beam activation (or beam sweeping, or beam hopping) is required to cover a potential ground service area. Exemplarily, FIG. 2 illustrates a portion of cells within the potential ground service area of a satellite. At time instant t0, the satellite activates the satellite beams corresponding to cell #1 and cell #4; and at time instant t1, the satellite activates the satellite beams corresponding to cell #2 and cell #5. In this way, the time-division beamforming achieves the system-wide coverage expansion, thereby providing services to the potential ground area.

In related arts, a terminal device assumes a 20 ms SSB periodicity during an initial cell selection. However, the beam corresponding to the terminal device fails to be activated within 20 ms to transmit the SSB, resulting in a cell search failure on the terminal device.

The method for wireless communication according to the embodiments of the present disclosure may extend the SSB periodicity determined by the terminal device during the initial cell selection, such that the terminal device is allowed to receive the SSB within the SSB periodicity. The technical solutions according to the present disclosure are described using a scenario illustrated in FIG. 2 as an example.

FIG. 3 is a flowchart of a method for wireless communication according to some embodiments of the present disclosure. The method is applicable to the network architecture illustrated in FIG. 1, and includes step 310.

In 310, a terminal device receives an SSB from a network device within a first periodicity, wherein the first periodicity is greater than or equal to 20 ms.

In some embodiments, the first periodicity is related to a first frequency band, wherein the frequency band is a frequency band on which the terminal device performs a cell search.

In some embodiments, the terminal device determines the first periodicity based on the frequency band on which the terminal device performs the cell search. Exemplarily, during an initial cell selection, the terminal device determines the first periodicity based on the current frequency band on which the cell search is performed.

In some embodiments, the terminal device determines an SSB SCS, an SSB pattern, and an SSB periodicity on a synchronization grid of the frequency band to determine the first periodicity for receiving the SSB. The synchronization grid refers to all frequency points that may be used to transmit a synchronization signal within a frequency band supported by the terminal device for blind detection in a case where the terminal device has not yet determined a frequency point for the synchronization signal.

Exemplarily, as illustrated in Table 1, the terminal device determines the first periodicity based on the current frequency band on which the cell search is performed. For example, in a case where the current frequency band (the first frequency band) on which the cell search is performed is n256, the terminal device determines the first periodicity to be 80 ms.

In some embodiments, the first periodicity is further related to an SCS of the first frequency band.

Exemplarily, as illustrated in Table 1, the current frequency band on which the cell search is performed is n255. In a case where the SCS of the first frequency band is 15 kHz, the terminal device determines the first periodicity to be 80 ms. In a case where the SCS of the first frequency band is 30 kHz, the terminal device determines the first periodicity to be 40 ms.

In some embodiments, in a case where the terminal device has not yet received the SSB on the current frequency band, the terminal device may switch to other frequency bands to receive the SSB. Exemplarily, in a case where the terminal device has not yet received the SSB on the frequency band n256, the terminal device may switch to the frequency band n255 to receive the SSB.

In some embodiments, in a case where the terminal device has not yet received the SSB on the current frequency band within the first periodicity, the terminal device switches to other frequency bands and receives the SSB based on the first periodicity determined by the other frequency bands.

TABLE 1
synchronization grid and SSB periodicity
adopted by the NTN frequency band

| NTN | | | | GSCN range (starting |
|---|---|---|---|---|
| frequency | | SSB | SSB | position-<step length>- |
| band | SSB SCS | pattern | periodicity | ending position) |
| n256 | 15 kHz | Pattern A | 80 ms | 5429-<1>-5494 |
| n255 | 15 kHz | Pattern A | 80 ms | 3818-<1>-3892 |
| | 30 kHz | Pattern B | 40 ms | 3824-<1>-3886 |

In some embodiments, the network device transmits the SSB to a serving cell of the terminal device.

In some embodiments, the network device transmits the SSB to the serving cell of the terminal device based on the first periodicity.

In some embodiments, the periodicity within which the network device transmits the SSB is a third periodicity, wherein the third periodicity is less than or equal to the first periodicity.

In some embodiments, the network device determines the third periodicity based on the first periodicity.

In some embodiments, the network device determines the third periodicity based on a second frequency band, wherein the second frequency band is the frequency band on which the network device transmits the SSB. Exemplarily, in a case where the network device transmits the SSB on the frequency band n256, the network device determines the third periodicity to be less than or equal to 80 ms.

In some embodiments, the network device determines the third periodicity based on the second frequency band and the SCS of the second frequency band. Exemplarily, the network device transmits the SSB on the frequency band n255. In a case where the SCS of the second frequency band is 15 kHz, the network device determines the third periodicity to be less than or equal to 80 ms. In a case where the SCS of the second frequency band is 30 kHz, the network device determines the third periodicity to be less than or equal to 40 ms.

In some embodiments, the network device is the satellite illustrated in FIG. 2.

In some embodiments, the network device transmits the SSB to a plurality of cells. Exemplarily, as illustrated in FIG. 2, the network device transmits the SSB to cell #1 and cell #4 at time instant t0, and transmits the SSB to cell #2 and cell #5 at time instant t1.

In some embodiments, the network device completes the SSB transmission to all the cells in a coverage range of the network device within the first periodicity. As an exemplary scenario illustrated in FIG. 2, the network device completes the SSB transmission to cells #0 to #5 within the first periodicity.

In some embodiments, the network device completes the SSB transmission to all the cells in a coverage range of the network device within the third periodicity. As an exemplary scenario illustrated in FIG. 2, the network device completes the SSB transmission to cells #0 to #5 within the third periodicity, wherein the third periodicity is less than or equal to the first periodicity.

In some embodiments, the third periodicity may be greater than 20 ms, or less than 20 ms, or equal to 20 ms, which is not limited in this disclosure.

In the technical solutions according to the embodiments of the present disclosure, the terminal device receives the SSB from the network device within the first periodicity, wherein the first periodicity is greater than or equal to 20 ms; and the SSB periodicity is extended to the first periodicity, such that the terminal device is capable of receiving the SSB within the first periodicity, thereby preventing cell search failures and improving communication efficiency.

Additionally, determining the first periodicity based on the cell search ensures that the terminal device and the network device are synchronized regarding the first periodicity, such that that the terminal device is capable of receiving receive the SSB within the first periodicity.

In some embodiments, upon receiving the SSB, the terminal device needs to further monitor a physical downlink control channel (PDCCH) to receive a system message.

In some embodiments, the method further includes step 320 (not illustrated).

In 320, the terminal device monitors the PDCCH based on the second periodicity.

In some embodiments, the terminal device monitors a Type0-PDCCH base on a second periodicity.

In some embodiments, for an SSB and control resource set (CORESET0) multiplexing mode 1, the terminal device monitors the PDCCH on a Type0-PDCCH common search space (CSS) across two slots. For a cell SSB #i, the terminal device determines an index of the slot n₀ to be

$${n}_{0} = ( O \cdot {2}^{μ} + ⌊ i \cdot M ⌋ ) mod {N}_{slot}^{frame , μ} ,$$

i. e., the slot n₀ on a frame SFN_{C} satisfies: in a case where

$$⌊ ( O \cdot {2}^{μ} + ⌊ i \cdot M ⌋ ) / {N}_{slot}^{frame , μ} ⌋ mod 2 = 0 ,$$

SFN_{C} mod 2=0; or in a case where

$$⌊ ( O \cdot {2}^{μ} + ⌊ i \cdot M ⌋ ) / {N}_{slot}^{frame , μ} ⌋ mod 2 = 1 ,$$

SFN_{C} mod 2=1, wherein μ is determined according to the SCS of the PDCCH within the CORESET. O is used to determine the starting point of a PDCCH monitoring occasion corresponding to a first SSB, and M is used to determine to a degree of overlap of the PDCCH monitoring occasion corresponding to the SSB #i and SSB #i+1. For example, M=2 indicates that there is no overlap, M=1 indicates that the overlap is one slot, M=½ indicates that there is a complete overlap.

In some embodiments, for a μϵ{0,1,2,3} and the SSB #i, the two slots associated with a Type0-PDCCH monitoring occasion are respectively n₀ and n₀+1, i. e., a first symbol index of the CORESET within M, O and no, n₀+1 are indicated in a candidate value set preconfigured from a pdcch-ConfigSIB1 information field carried on a PBCH.

In some embodiments, for the SSB and CORESET0 multiplexing mode 1, the Type0-PDCCH monitoring periodicity is 20 ms. In a case where the periodicity of the SSB becomes the first periodicity by the 20 ms extension, the Type0-PDCCH monitoring periodicity may be extended to become the second periodicity. For example, the second periodicity is 80 ms to match an activation pattern of the satellite beam.

In some embodiments, the second periodicity is determined based on the first periodicity.

In some embodiments, the second periodicity equals the first periodicity. Exemplarily, in a case where the first periodicity is 80 ms, the second periodicity is also determined to be 80 ms.

In some embodiments, the first periodicity is an integer multiple of the second periodicity. Exemplarily, in a case where the first periodicity is 80 ms, the second periodicity is determined to be 20 ms.

In some embodiments, the second periodicity is indicated by the SSB.

In some embodiments, the SSB may explicitly indicate the second periodicity, or implicitly indicate the second periodicity, which is not limited in the present disclosure.

In some embodiments, the SSB carries first information, the first information being used to indicate the second periodicity among a plurality of periodicities.

In some embodiments, the first information may be information bits carried within the SSB.

In some embodiments, the first information may be carried on the PBCH. In some embodiments, the first information may be indicated by the information bits carried on the PBCH.

In some embodiments, the plurality of periodicities are candidate values for a pre-configuration. Exemplarily, the plurality of periodicities are presented in Table 2.

TABLE 2
candidate values of the Type0-PDCCH monitoring
periodicity and CORESET multiplexing mode 1

| | Monitoring periodicity |
|---|---|
| Index | for Type0-PDCCH |
| 0 | 20 ms |
| 1 | 40 ms |
| 2 | 60 ms |
| 3 | 40 ms |

Exemplarily, in a case where the first information is used to indicate that the index of the second periodicity is 1, the terminal device determines the second periodicity to be 40 ms based on the first information.

Exemplarily, the first information is used to indicate that the second periodicity is 40 ms.

By extending the periodicity in which the terminal device monitors the PDCCH to the second periodicity, wherein the second periodicity may be determined based on the first periodicity, or based on the first information carried by the SSB, the method ensures that the PDCCH monitoring periodicity of the terminal device matches the periodicity of the corresponding satellite beam.

In some embodiments, the method further includes step 330 (not illustrated).

In 330, the terminal device determines the first periodicity based on the second periodicity.

In some embodiments, in a case where the second periodicity is indicated by the SSB, the terminal device determines the first periodicity based on the second periodicity.

In some embodiments, in a case where the second periodicity is indicated by the first information carried within the SSB, the terminal device determines the first periodicity based on the second periodicity.

Exemplarily, the plurality of periodicities are presented in Table 2. In a case where the first information is used to indicate the second periodicity among the plurality of periodicities in Table 2, the first periodicity may be determined by the second periodicity. In an exemplary embodiment, the first periodicity may be equal to the second periodicity. For example, the terminal device determines the first periodicity to be 60 ms based on the second periodicity. In another exemplary embodiment, the first periodicity may be an integer multiple of the second periodicity. In a case where the second periodicity is 20 ms, the terminal device determines the first periodicity to be 80 ms.

In some embodiments, upon receiving the SSB, the terminal device performs step 330 to update the first periodicity.

Exemplarily, prior to receiving the SSB, the terminal device determines the first periodicity based on the first frequency band. Upon receiving the SSB, the terminal device determines the first periodicity based on the second periodicity. For example, prior to receiving the SSB, the terminal device determines the first periodicity to be 80 ms based on the first frequency band, and upon receiving the SSB, the terminal device determines the first periodicity to be 60 ms based on the second periodicity.

In some embodiments, in a case where the ground service range provided by the satellite is relatively small, the network device may transmit the SSB with a smaller SSB periodicity associated with its frequency band in Table 1. For instance, in a case where the periodicity is 40 ms, the terminal device receives the SSB based on the SSB periodicity associated with its frequency band in Table 1 prior to determining the second periodicity; and upon determining the second periodicity, the terminal device receives the SSB based on the first periodicity determined by the second periodicity.

In some embodiments, the method further includes step 340 (not illustrated).

In 340, the terminal device determines, based on a time-domain position of the SSB, a time-domain position for monitoring the PDCCH.

In some embodiments, the terminal device determines the time-domain position of the SSB as the time-domain position for monitoring the PDCCH.

In some embodiments, the terminal device determines, based on the time-domain position of the SSB and an offset value between the time-domain position of the SSB and the time-domain position of the PDCCH, the time-domain position for monitoring the PDCCH.

In some embodiments, the offset value may be configured by the network device, predefined, or preconfigured, which is not limited in the present disclosure.

In some embodiments, in a case where the offset value is predefined or preconfigured, the offset value is a default value or a fixed value.

In some embodiments, in a case where the offset value is configured by the network device, the offset value may be indicated by the SSB.

In some embodiments, the offset value may be carried in the information bits of the SSB. In some embodiments, the offset value may be carried in the information bits carried on the PBCH.

In some embodiments, the SSB is used to indicate one offset value among a plurality of offset values. Exemplarily, the plurality of offset values are listed in Table 3.

TABLE 3
offset values corresponding to time-domain positions
of the PDCCH and time-domain positions of the
SSB (SSB and CORESET multiplexing mode 1)

| Index | Offset value |
|---|---|
| 0 | 0 |
| 1 | 2 |
| 2 | 4 |
| 3 | 8 |

Exemplarily, in a case where the SSB indicates that the index of the offset value is 1, the terminal device determines that the offset value corresponding to the time-domain position of the PDCCH and the time-domain position of the SSB is 2.

In some embodiments, the plurality of offset values are preconfigured or predefined.

In some embodiments, the terminal device determines a frame index of the PDCCH based on an SSB frame index. The SSB frame index refers to an index of a frame of the SSB, and the frame index of the PDCCH refers to an index of a frame. In some embodiments, a slot index and a symbol index corresponding to the PDCCH may also be determined using the time-domain position of the SSB.

In some embodiments, the frame index is determined based on a time length of the second periodicity.

In some embodiments, the frame index is determined based on the periodicity of 20 ms.

In some embodiments, for the SSB and the CORESET0 multiplexing mode 1, in a case where the PDCCH monitoring periodicity is extended to the second periodicity, the terminal device determines a frame SFN_{C} on the corresponding Type0-PDCCH monitoring occasion based on a frame SFN_{SSB,i} of the cell SSB #i. For example, in a case where SFN_{C}=SFN_{SSB,i} or, SFN_{C}=SFN_{SSB,i}+Offset_{SSB_PDCCH}, wherein Offset_{SSB_PDCCH} is a frame offset value of the SFN_{C} relative to the SFN_{SSB,i}, the value may be the default value, or a value within a preconfigured candidate set indicated by information bits carried on the PBCH, as listed in Table 4.

TABLE 4
frame offset value of the SFN_{C} relative to the
SFN_{SSB, i} (SSB and CORESET multiplexing mode 1)

| Index | Frame offset value |
|---|---|
| 0 | 0 |
| 1 | 2 |
| 2 | 4 |
| 3 | 8 |

By the above method, the terminal device determines the frame containing the corresponding Type0-PDCCH monitoring occasion based on the frame containing the cell SSB #i, thus ensuring that the terminal device is able to determine the PDCCH monitoring occasion based on the SSB.

Considering that the terminal device can only receive the SSB when its corresponding satellite beam is active, it is advantageous for the terminal device to conserve energy by further receiving the SSB based on a first pattern upon determining the first periodicity.

In some embodiments, step 310 may also be implemented as step 311 as follows.

In 311, within the first periodicity, the terminal device receives the SSB from the network device based on the first pattern, the first pattern being at least one first time window within the first periodicity, and the first time window is a time window within which the network device transmits the SSB to a serving cell of the terminal device.

In some embodiments, the terminal device receives the SSB within the at least one first time window in the first pattern.

In some embodiments, a duration of the first time window allows transmission for Lₘₐₓ number of SSBs, wherein Lₘₐₓ is a maximum value of a cell SSB index, i.e., the maximum number of SSB transmitted within a half-frame is Lₘₐₓ. For example, the duration of the first time window may be one or a plurality of half-frames, or a plurality of slots or milliseconds. As illustrated in FIG. 4, the duration of the first time window is 3 ms, in a case where the cell adopts the SSB structure of pattern A, 2 slots are needed to transmit Lₘₐₓ=4 SSBs. In this way, the first time window with the duration of 3 ms may satisfy the SSB transmission requirement.

In some embodiments, any one of a number of first time windows, a periodicity, and a duration within a first periodicity is defined by a protocol or indicated by a network device.

Exemplarily, any one of a number of first time windows, a periodicity, and a duration within a first periodicity is indicated by at least one of a system message or a switch command.

For a time-domain position of the first time window of different satellite beams or cells within the first periodicity, the following design is implemented:

For ease of description, the cells for which the corresponding satellite beams are activated simultaneously are defined as one cell group, whereas the cells for which the corresponding satellite beams are not activated simultaneously belong to different cell groups. In a case where N cell groups are present within a ground service area for potential satellite service, e.g., {cell group #0, cell group #1, . . . cell group N−1}, a design for the first time window for different cell groups is as follows:

In some embodiments, the network device transmits the SSB to different cell groups across different time-domain positions, and frame boundaries of the different cell groups are offset by the at least one first time window.

In some embodiments, time-domain unit indexes corresponding to time windows within which the network device transmits the SSB to different cell groups are the same.

Exemplarily, as illustrated in FIG. 5, the frame boundaries of cell group #1 and cell group #2 are offset by a duration of at least one first time window, and the frame boundaries of cell group #2 and cell group #3 are offset by a duration of at least one first time window. In this case, slot indexes corresponding to the first time windows of the three cell groups are all slot #0-slot #2. It should be understood that the slot indexes corresponding to the first time windows of the three cell groups may or may not be the same, which is not limited in the present disclosure.

In some embodiments, the time-domain unit index may be a slot index, or a frame index, which is not limited in the present disclosure.

In some embodiments, the network device transmits the SSB to different cell groups across different time-domain positions, and the frame boundaries of the different cell groups are aligned.

In some embodiments, the time-domain unit indexes corresponding to the time windows within which the network device transmits the SSB to different cell groups are different.

Exemplarily, as illustrated in FIG. 6, the frame boundaries of cell group #1, cell group #2, and cell group #3 are aligned. In this case, the slot indexes corresponding to the first time windows of cell group #1, cell group #2, and cell group #3 are slot #0-slot #2, slot #3-slot #5, and slot #6-slot #8, respectively. It should be understood that indexes corresponding to the first time windows of the three cell groups may or may not be the same, which is not limited in the present disclosure.

In the above method, the frame boundaries of different cell groups are offset by one or more first time windows, or the first time windows of different cell groups correspond to different time-domain indexes. In this way, the satellite beams corresponding to different cell groups are activated using a time-division scheme, and thus the satellite coverage under the constraints of limited satellite power and processing capacities are effectively expanded.

Considering that in the related arts, transmission of an SSBs always starts from a first slot within a half-frame, whereas an SSB within a first time window may be transmitted on any slot, in some embodiments, the terminal device receives the SSB within the first time window for cell synchronization, wherein the SSB is a candidate SSB in a candidate SSB set.

In some embodiments, the SSB is the one candidate SSB in the candidate SSB set, wherein the candidate SSB set includes at least one candidate SSB, wherein the at least one candidate SSB is distributed according to an SSB pattern.

In some embodiments, the candidate SSB set includes at least five candidate SSBs, the candidate SSBs are distributed in each time unit within the half-frame according to the SSB pattern, and the indexes are incremented according to time, wherein the time unit is a slot or milliseconds.

In some embodiments, for SCS=15 kHz, each slot within the half-frame includes two candidate SSBs. FIG. 7 illustrates an exemplary candidate SSB pattern, wherein first symbol indexes of the candidate SSBs are {2, 8}+14·n, n=0, 1, 2, 3, 4, respectively.

In some embodiments, for SCS=30 kHz, two candidate SSBs are included in every 2 slots within the half-frame. For example, each slot within the half-frame includes one candidate SSB. FIG. 8 illustrates an exemplary candidate SSB pattern, wherein the first symbol indexes of the candidate SSBs are {4, 16}+28·n, n=0, 1, 2, 3, 4, respectively.

In some embodiments, for SCS=30 kHz, each slot within the half-frame includes two candidate SSBs. FIG. 9 illustrates an exemplary candidate SSB pattern, wherein the first symbol indexes of the candidate SSBs are {4, 8}+28 n, n=0, 1, 2, 3, 4.

In some embodiments, the method further includes at least one step of step 350 to 360 (not illustrated).

In 350, a second time window is determined based on the first time window, wherein the second time window is a time window within which the network device transmits the SSB to a neighboring cell of the terminal device.

In some embodiments, the second time window may be referred to as the first time window of the neighboring cell, which is not limited in the present disclosure.

In 360, the SSB of the neighboring cell received based on the second time window within the first periodicity.

In some embodiments, the terminal device may perform neighboring cell measurements based on the time-domain position of the first time window (i.e., the second time window) within the first periodicity. For example, in a case where the frame boundaries of the different cell groups are offset by one or more first time windows, the terminal device may determine the first time window of the neighboring cell based on a number of time windows offsetting the frame boundaries of the serving cell and the neighboring cell, and hence receive the SSB within the first time window of the neighboring cell to measure the neighboring cell. As another example, in a case where the slot indexes corresponding to the first time windows of the different cell groups are different, the terminal device may determine the first time window based on the slot index corresponding to the first time window of the neighboring cell, and hence receive the SSB within the first time window of the neighboring cell to measure the neighboring cell.

In some embodiments, the method further includes step 370 (not illustrated).

In 370, the terminal device determines a time-domain unit containing the SSB based on the candidate SSB pattern and an index of the candidate SSB corresponding to the SSB.

In some embodiments, the time-domain unit containing the SSB includes a slot and symbol containing the SSB.

For cell synchronization, the terminal device needs to determine the slot and symbol containing the received SSB. In some embodiments, the terminal device determines the slot and symbol containing the received SSB based on the index of the candidate SSB corresponding to the SSB pattern and the received SSB.

In some embodiments, the index of the candidate SSB corresponding to the SSB is determined based on an index of at least one of second information or a DMRS sequence carried in the SSB, wherein the second information include information bits on a PBCH. Exemplarily, the terminal device determines, based on a one-to-one mapping, the three LSBs of the index of the candidate SSB from the index of the DMRS sequence transmitted on the PBCH, and determines one MSB of the index of the candidate SSB based on information bit ā_{Ā+7} on the PBCH.

A cell SSB index is the SSB index corresponding to the SSB in an SSB set transmitted within the cell, and the terminal device determines the cell SSB set and monitors the PDCCH based on the cell SSB index. For an NTN frequency band, a maximum number of SSBs that the cell transmits within the half-frame is Lₘₐₓ=4, occupying four consecutive SSBs within the candidate SSB set. FIG. 10 illustrates an exemplary cell SSB set, wherein the candidate SSBs are evenly distributed to each slot within the half-frame. However, the cell SSB starts in slot #3 and corresponds to candidate SSBs #6 to 9 in slots #3 to 4, i. e., the first symbol indexes of the cell SSB are {2, 8}+14·n, n=3,4, respectively.

In some embodiments, the SSB carries third information, wherein the third information is used to indicate the cell SSB index corresponding to the SSB, and the cell SSB index is the index of the SSB in the cell SSB index set.

Exemplarily, in a case where the transmission of the cell SSB starts from a slot boundary corresponding to an SCS=15 kHz, based on the candidate SSB pattern, and subsequent to the network device further indicating that the current SSBs are the first two SSBs or the last two SSBs in the cell SSB set, the terminal device may determine the cell SSB index corresponding to the current SSB based on the candidate SSB pattern. For example, the terminal device determines the received cell SSB index corresponding to the SSB based on information bit ā_{Ā+6} on the PBCH, for example, the terminal device determines that the received SSBs are the first two SSBs or the last two SSBs in the cell SSB set, and hence determines the cell SSB index corresponding to the SSB.

In some embodiments, the terminal device determines the cell SSB index corresponding to the SSB based on the SSB pattern and the third information. Exemplarily, the terminal device determines the index of the candidate SSB based on the third information, and further determines the cell SSB index corresponding to the SSB based on the index of the candidate SSB and the candidate SSB pattern.

In some embodiments, the third information may be information identical to the second information, or information different than the second information, which is not limited in the present disclosure. In some embodiments, in a case where the third information is information identical to the second information, the third information is the second information.

By the above method, the terminal device receives the SSB within the first time window, the SSB being the candidate SSB in the candidate SSB set, wherein the SSBs are distributed across each time unit within the half-frame according to the candidate SSB pattern, such that the network device is allowed to start transmitting the cell SSB on any slot.

The terminal device determines the index of the candidate SSB and the cell SSB index based on at least one of the DMRS sequence or the information bits carried on the PBCH. This ensures that the terminal device may perform the cell synchronization, determine the cell SSB set, and monitor the PDCCH based on the received SSB.

The following describes embodiments illustrating an apparatus according to the present disclosure, which may be used to implement the method embodiments of the present disclosure. For details not disclosed in the apparatus embodiments, reference may be made to the method embodiments of the present disclosure.

FIG. 11 is a block diagram of an apparatus for wireless communication according to the embodiments of the present disclosure. The apparatus has a function to implement the method for wireless communication of the terminal device as described above. The function may be implemented via hardware, software, or via hardware executing the corresponding software. The apparatus may be the terminal device described above, or may be implemented as part of the terminal device. As illustrated in FIG. 11, the apparatus 1100 may include a receiving module 1110.

The receiving module is configured to receive, within a first periodicity, an SSB from a network device, wherein the first periodicity is greater than or equal to 20 ms.

In some embodiments, the first periodicity is related to a first frequency band, wherein the first frequency band is a frequency band on which the terminal device performs a cell search.

In some embodiments, the first periodicity is further related to an SCS of the first frequency band.

In some embodiments, the receiving module 1110 is further configured to monitor a PDCCH based on a second periodicity.

In some embodiments, the second periodicity is determined based on the first periodicity.

In some embodiments, the second periodicity equals the first periodicity, or the first periodicity is an integer multiple of the second periodicity.

In some embodiments, the second periodicity is indicated by the SSB.

In some embodiments, the SSB carries first information, wherein the first information is used to indicate the second periodicity among a plurality of periodicities.

In some embodiments, the apparatus 1100 further includes a processing module (not illustrated).

The processing module is configured to determine the first periodicity based on the second periodicity.

In some embodiments, the processing module is configured to determine, based on a time-domain position of the SSB, a time-domain position for monitoring the PDCCH.

In some embodiments, the receiving module 1110 is configured to receive, within the first periodicity and based on a first pattern, the SSB from the network device, wherein the first pattern is at least one first time window within the first periodicity, and the first time window is a time window within which the network device transmits the SSB to a serving cell of the terminal device.

In some embodiments, any one of a number, a periodicity, or a duration of the at least one first time window within the first periodicity is defined by a protocol, or indicated by the network device.

In some embodiments, the network device transmits the SSB to different cell groups across different time-domain positions, wherein frame boundaries of the different cell groups are offset by the at least one first time window.

In some embodiments, time-domain unit indexes corresponding to the time windows within which the network device transmits the SSB to different cell groups are the same.

In some embodiments, the network device transmits the SSB to different cell groups across different time-domain positions, wherein frame boundaries of the different cell groups are aligned.

In some embodiments, the time-domain unit indexes corresponding to the time windows within which the network device transmits the SSB to the different cell groups are different.

In some embodiments, the processing module is configured to determine a second time window based on the first time window, wherein the second time window is a time window within which the network device transmits the SSB to a neighboring cell of the terminal device; and

The receiving module is further configured to receive, within the first periodicity and based on the second time window, the SSB of the neighboring cell.

In some embodiments, the SSB is a candidate SSB in a candidate SSB set, wherein the candidate SSB set includes at least one candidate SSB, the at least one candidate SSB being distributed according to a candidate SSB pattern.

In some embodiments, the processing module is configured to determine the time-domain unit containing the SSB based on the SSB pattern and an index of the candidate SSB corresponding to the SSB.

In some embodiments, the index of the candidate SSB corresponding to the SSB is determined based at least one of second information carried by the SSB or an index of a DMRS sequence, wherein the second information include information bits carried on a PBCH.

In some embodiments, the SSB contains third information, wherein the third information is used to indicate a cell SSB index corresponding to the SSB, the cell SSB index being an index of the SSB in a cell SSB set.

The technical solutions according to the embodiments of the present disclosure, in which the terminal device receives the SSB from the network device within the first periodicity, extends the SSB periodicity to the first periodicity, wherein the first periodicity is greater than or equal to 20 ms. This extension allows the terminal device to receive the SSB within the first periodicity, avoiding cell search failure, thereby improving the communication efficiency.

FIG. 12 is a block diagram of an apparatus for wireless communication according to some embodiments of the present disclosure. The apparatus has a function to implement the method for wireless communication of the network device in the above. The function may be implemented via hardware, or via hardware executing the corresponding software. The apparatus may be the network device described above, or may be implemented as part of the network device. As illustrated in FIG. 12, the apparatus 1200 may include: a transmitting module 1210.

The transmitting module 1210 is configured to transmit, based on a first periodicity, an SSB to a serving cell of a terminal device, wherein the first periodicity is greater than or equal to 20 ms.

In some embodiments, the first periodicity is related to a first frequency band, wherein the first frequency band is a frequency band on which the terminal device performs a cell search.

In some embodiments, the first periodicity is further related to an SCS of the first frequency band.

In some embodiments, the transmitting module 1210 is further configured to transmit a PDCCH to the terminal device based on a second periodicity.

In some embodiments, the second periodicity is determined based on the first periodicity.

In some embodiments, the second periodicity is equal to the first periodicity, or the first periodicity is an integer multiple of the second periodicity.

In some embodiments, the second periodicity is indicated by the SSB.

In some embodiments, the SSB carries first information, wherein the first information is used to indicate the second periodicity among a plurality of periodicities.

In some embodiments, the second periodicity is used to determine the first periodicity.

In some embodiments, a time-domain position of the PDCCH is determined based on a time-domain position of the SSB.

In some embodiments, the transmitting module 1210 is further configured to transmit, within the first periodicity and based on the first pattern, the SSB to the terminal device, wherein the first pattern is at least one first time window within the first periodicity, and the first time window is a time window within which the network device transmits the SSB to a serving cell of the terminal device.

In some embodiments, any one of a number, a periodicity, or a duration of the at least one first time window within the first periodicity is defined by a protocol, or indicated by the network device.

In some embodiments, the network device transmits the SSB to different cell groups across different time-domain positions, wherein frame boundaries of the different cell groups are offset by the at least one first time window.

In some embodiments, time-domain unit indexes corresponding to the time windows within which the network device transmits the SSB to different cell groups are the same.

In some embodiments, the network device transmits the SSB to different cell groups across different time-domain positions, wherein frame boundaries of the different cell groups are aligned.

In some embodiments, the time-domain unit indexes corresponding to the time windows within which the network device transmits the SSB to the different cell groups are different.

In some embodiments, the transmitting module 1210 is further configured to transmit, within a second periodicity and based on a second time window, the SSB to a neighboring cell of the terminal device, wherein the second time window is a time window within which the network device transmits the SSB to the neighboring cell.

In some embodiments, the SSB is a candidate SSB in a candidate SSB set, the candidate SSB set including at least one candidate SSB, wherein the at least one candidate SSB is distributed based on a candidate SSB pattern.

In some embodiments, a time-domain unit containing the SSB is determined by the candidate SSB pattern and an index of the candidate SSB.

In some embodiments, the index of the candidate SSB corresponding to the SSB is determined based on at least one of second information carried in the SSB or an index of a DMRS sequence, wherein the second information includes information bits on a PBCH.

In some embodiments, the SSB carries third information, wherein the third information being used to indicate a cell SSB index corresponding to the SSB, the cell SSB index being an index of the SSB in a cell SSB set.

The technical solutions according to the embodiments of the present disclosure, in which the terminal device receives the SSB from the network device within the first periodicity, extend the SSB periodicity to the first periodicity, wherein the first periodicity is greater than or equal to 20 ms. This extension allows the terminal device to receive the SSB within the first periodicity, avoiding cell search failure, thereby improving the communication efficiency.

It should be noted that the apparatus according to the above embodiments is only described by way of example in terms of the definition of functional modules when implementing its functions. In practice, the functions may be assigned to be completed by different functional modules as needed. That is, the device or apparatus may be designed to have different functional modules to implement part or all of the functions as described above.

Regarding the apparatus described in the above embodiments, the specific details regarding each module performing operations have been given in detail in the above method embodiments of the present disclosure, which are not elaborated herein.

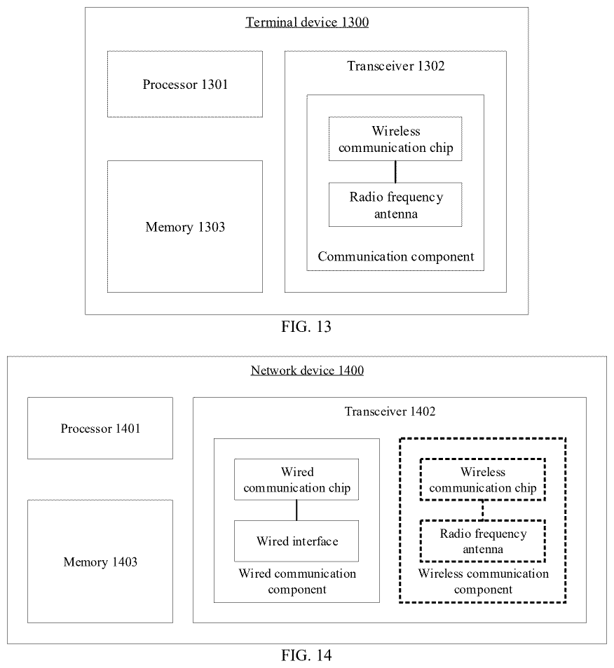

FIG. 13 is a schematic structural diagram of a terminal device according to some embodiments of the present disclosure. The terminal device may include a processor 1301, a transceiver 1302, and a memory 1303. The transceiver 1302 is configured to implement transmission or reception, such as the function of the receiving module 1110. The processor 1301 is configured to implement other functionalities or to control transmission and/or reception, such as the function of the processing module.

The processor 1301 includes one or more processing cores, and the processor 1301 executes various functional applications and information processing by running software programs and modules.

The transceiver 1302 may include a receiver and a transmitter, for example, the receiver and the transmitter may be implemented as one wireless communication component, wherein the communication component may include a wireless communication chip and a radio frequency (RF) antenna.

The memory 1303 may be communicably connected to the processor 1301 and the transceiver 1302.

The memory 1303 is configured to store one or more computer programs, wherein the processor 1301 is configured to call and run the one or more computer programs to perform each step of the method embodiments of the present disclosure.

In some embodiments, the transceiver 1302 is configured to receive within a first periodicity, an SSB from the network device, wherein the first periodicity is greater than or equal to 20 ms.

For details not disclosed in this embodiment, reference may be made to the above embodiments of the present disclosure, which are not elaborated herein.

Additionally, the memory 1403 may be implemented by any type of transitory or non-transitory storage device or a combination thereof, and the transitory or non-transitory storage device includes but is not limited to: a disk or an optical disc, an electrically erasable programmable read-only memory (EEPROM), an erasable programmable read-only memory (EPROM), a static random-access memory (SRAM), a read-only memory (ROM), a magnetic storage, a flash memory, or a programmable read-only memory (PROM).

FIG. 14 is a schematic structural diagram of a network device according to some embodiments of the present disclosure. The network device 1400 is configured to implement the method steps performed by the network device in the method embodiments of the present disclosure. The network device may include: a processor 1401, a transceiver 1402, and a memory 1403. The transceiver 1402 is configured to implement transmission and reception functionalities, such as the function of the transmitting module 1210. The processor 1401 may be configured to implement other functionalities or to control transmission and/or reception.

The processor 1401 includes one or more processing cores, and the processor 1401 executes various functional applications and information processing by running software programs and modules.

The transceiver 1402 may include a receiver and a transmitter, for example, the transceiver may include wired communication component, wherein the wired communication component may include a wired communication chip and a wired interface (e.g., an optical fiber interface). Optionally, the transceiver 1402 may include a wireless communication component, wherein the wireless communication component may include a wireless communication chip and an RF antenna.

The memory 1403 may be communicably connected to the processor 1401 and the transceiver 1402.

The memory 1403 is configured to store one or more computer programs, wherein the processor 1401 is configured to call and run the one or more computer programs to perform each step of the method embodiments of the present disclosure.

Additionally, the memory 1403 may be implemented by any type of transitory or non-transitory storage device or a combination thereof, and the transitory or non-transitory storage device includes but is not limited to: a disk or an optical disc, an EEPROM, an EPROM, an SRAM, a ROM, a magnetic storage, a flash memory, or a PROM.

In some embodiments, the transceiver 1402 is configured to transmit, within a first periodicity, an SSB to a neighboring cell of a terminal device, wherein the first periodicity is greater than or equal to 20 ms.

For details not disclosed in the embodiments, reference may be made to the above embodiments of the present disclosure, which are not elaborated herein.

Some embodiments of the present disclosure further provide a computer-readable storage medium storing one or more computer programs, wherein the one or more computer programs are called and executed by the processor to implement the method for wireless communication from the terminal device end, or the method for wireless communication from the network device end. The computer-readable storage medium may include: a ROM, a random-access memory (RAM), a solid state drive (SSD), an optical disk, and the like. The RAM may include a resistive random-access memory (ReRAM) and a dynamic random-access memory (DRAM).

Some embodiments of the present disclosure further provide a chip. The chip includes programmable electric logic circuitry and/or one or more computer instructions, wherein the chip, when running on the communication device, implements the method for wireless communication from the terminal device end, or the method for wireless communication from the network device end.

Some embodiments of the present disclosure further provide a computer program product. The computer program product includes one or more computer instructions, wherein the one or more computer instructions are stored in the computer-readable storage medium. The one or more computer programs, when loaded and run by a processor, causes a computer device to perform the method for wireless communication from the terminal device end, or the method for wireless communication from the network device end.

It should be understood that the term “indication” mentioned in the embodiments of the present disclosure refers to a direct indication, an indirect indication, or an indication that there is an association relationship. For example, A indicates B, which may mean that A indicates B directly, e. g., B may be acquired by A, or that A indicates B indirectly, e.g., A indicates C by which B may be acquired, or that an association relationship is present between A and B.

In the description of the embodiments of the present disclosure, the term “correspond” indicates a direct or indirect corresponding relationship between two items, or indicates an associated relationship between two items; and also indicates relationships such as indicating and being indicated, or configuring and being configured.

In some embodiments of the present disclosure, the term “predefined” is implemented by pre-storing corresponding codes, tables, or other means that may be defined to indicate related message in devices (including, for example, terminal devices and network devices), and the present disclosure does not limit the specific implementation thereof. For example, the term “predefined” refers to being “defined” in a protocol.

In some embodiments of the present disclosure, the term “protocol” refers to a standard protocol in the communication field including, for example, the LTE protocol, the NR protocol, and related protocols applied in the future communication systems, which is not limited in the present disclosure.

The mentioned term “a plurality of” herein means two or more. The term “and/or” describes the association relationship between the associated objects, and indicates that three relationships may be present. For example, the phrase “A and/or B” means (A), (B), or (A and B). The symbol “/” generally indicates an “or” relationship between the associated objects.

Reference herein to “greater than or equal to” may indicate greater than or equal to or just greater than, and “less than or equal to” may indicate less than or equal to or just less than.

In addition, serial numbers of the processes described herein only show an exemplary possible sequence of performing the processes. In some other embodiments, the processes may also be performed out of the numbering sequence, for example, two process with different serial numbers are performed simultaneously, or two processes with different serial numbers are performed in reverse order to the illustrated sequence, which is not limited in the present disclosure.

Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C.

Those skilled in the art should understand that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

Described above are merely exemplary embodiments of the present disclosure and are not intended to limit the present disclosure. Any modifications, equivalent substitutions, improvements and the like, made within the spirit and principle of the present disclosure should fall within the protection scope of the present disclosure.

1. A method for wireless communication, performed by a terminal device, the method comprising:
receiving, within a first periodicity, a synchronization signal block (SSB) from a network device, wherein the first periodicity is greater than or equal to 20 ms.

2. The method according to claim 1, wherein the first periodicity is associated with a first frequency band, the first frequency band being a frequency band on which the terminal device performs a cell search.

3. The method according to claim 2, wherein the first periodicity is further associated with a subcarrier spacing (SCS) of the first frequency band.

4. The method according to claim 1, further comprising:
monitoring a physical downlink control channel (PDCCH) based on a second periodicity, wherein the second periodicity is determined based on the first periodicity, or the second periodicity is indicated by the SSB.

5. The method according to claim 4, wherein the SSB carries first information, the first information being used to indicate the second periodicity among a plurality of periodicities.

6. The method according to claim 4, further comprising:
determining, based on a time-domain position of the SSB, a time-domain position for monitoring the PDCCH.

7. The method according to claim 1, wherein the SSB is a candidate SSB in a candidate SSB set, the candidate SSB set comprising at least one candidate SSB, the at least one candidate SSB being distributed according to a candidate SSB pattern.

8. The method according to claim 7, further comprising:
determining, based on the candidate SSB pattern and an index of the candidate SSB corresponding to the SSB, a time-domain unit containing the SSB.

9. A terminal device, comprising:
a processor and a memory storing one or more computer programs, wherein the processor is configured to execute the one or more computer programs to:
receive, within a first periodicity, a synchronization signal block (SSB) from a network device, wherein the first periodicity is greater than or equal to 20 ms.

10. The terminal device according to claim 9, wherein the first periodicity is associated with a first frequency band, the first frequency band being a frequency band on which the terminal device performs a cell search.

11. The terminal device according to claim 9, wherein the processor is configured to execute the one or more computer programs to:
receive, within the first periodicity and based on a first pattern, the SSB from the network device, wherein the first pattern is at least one first time window within the first periodicity, and the first time window is a time window within which the network device transmits the SSB to a serving cell of the terminal device.

12. The terminal device according to claim 11, wherein the processor is configured to execute the one or more computer programs to:
determine a second time window based on the first time window, wherein the second time window is a time window within which the network device transmits the SSB to a neighboring cell of the terminal device; and
receive, within the first periodicity, the SSB of the neighboring cell based on the second time window.

13. A network device, comprising:
a processor and a memory storing one or more computer programs; wherein the processor is configured to execute the one or more computer programs to:
transmit, based on a first periodicity, a synchronization signal block (SSB) to a serving cell of a terminal device, wherein the first periodicity is greater than or equal to 20 ms.

14. The network device according to claim 13, wherein the first periodicity is associated with a first frequency band, the first frequency band being a frequency band on which the terminal device performs a cell search.

15. The network device according to claim 13, wherein the processor is configured to execute the one or more computer programs to:
transmit a physical downlink control channel (PDCCH) to the terminal device based on a second periodicity, wherein the second periodicity is determined based on the first periodicity, or the second periodicity is indicated by the SSB.

16. The network device according to claim 15, wherein the SSB carries first information, the first information being used to indicate the second periodicity among a plurality of periodicities.

17. The network device according to claim 13, wherein transmitting, based on the first periodicity, the SSB to a serving cell of the terminal device comprises:
transmitting, within the first periodicity and based on a first pattern, the SSB to the terminal device, wherein the first pattern is at least one first time window within the first periodicity, and the first time window is a time window within which the network device transmits the SSB to the serving cell of the terminal device.

18. The network device according to claim 17, wherein any one of a number, a periodicity, or a duration of the at least one first time window within the first periodicity is defined by a protocol, or indicated by the network device.

19. The network device according to claim 17, wherein the network device transmits the SSB to different cell groups across different time-domain positions, frame boundaries of the different cell groups being offset by the at least one first time window.

20. The network device according to claim 17, wherein the network device transmits the SSB to different cell groups across different time-domain positions, frame boundaries of the different cell groups being aligned.
